(19) United States
(12) Patent Application Publication
(10) Pub. No.: US 2020/0065180 A1
(43) Pub. Date: Feb. 27, 2020

(54) INTERNET OF THINGS BROKEN DEVICE ALERT SYSTEM AND METHOD

(71) Applicant: Asurvest, Inc. dba Fixt, Baltimore, MD (US)

(72) Inventor: Luke Cooper, Baltimore, MD (US)

(73) Assignee: Asurvest, Inc. dba Fixt, Baltimore, MD (US)

(21) Appl. No.: 16/549,333

(22) Filed: Aug. 23, 2019

Related U.S. Application Data
(60) Provisional application No. 62/722,530, filed on Aug. 24, 2018.

(51) Int. Cl. G06F 11/07

(52) U.S. Cl. CPC G06F 11/0778; G06F 11/0772; G06F 11/0787; G06F 11/0784; G06F 11/0769

(57) ABSTRACT

A system and method for executing a service request for repair or maintenance of a device on the Internet of things is disclosed. In one embodiment, the system comprises a database containing enterprise policy and device information necessary for service request execution which are accessed by policy and dispatch service modules when activated remotely by a support device. A method as described herein comprises activation, policy verification and dispatch authorization, all with the push of a button or other seamless activation means, resulting in the repair or maintenance of a device on the Internet of things according to predetermined policies of the enterprise. A system of the present invention may comprise provisioned applications enabling remote activation of service requests from outside an enterprise network, with or without added security features within the network. A system and method as described herein substantially limit the number of interactions required for efficient service.

### CROSS-REFERENCE TO RELATED APPLICATIONS

This application claims the benefit of priority of U.S. Provisional Pat. App. No. 62/722,530 filed Aug. 24, 2018, the contents of which are hereby incorporated by reference in their entirety.

### STATEMENT REGARDING FEDERALLY SPONSORED RESEARCH AND DEVELOPMENT

This invention was made without federal funding.

### BACKGROUND OF THE INVENTION

The invention of the present disclosure relates to a system and method for facilitating the repair of malfunctioning or otherwise compromised devices, appliances and the like connected on a network commonly known as the Internet of Things (IoT). An object of the invention is to eliminate or reduce the number of actions that must be taken by a user of a system of the present disclosure to resolve problems with connected devices on the IoT. Much time is currently spent by people troubleshooting issues with connected devices, determining who can fix problems, contacting technical support personnel to request service, and recording the actions taken to provide the necessary service for tracking purposes. In one embodiment, the present invention allows a user of a system disclosed herein to initiate an entire sequence of events with a press of a button and receive a predetermined level of customized service. In certain embodiments, a provisioned application incorporates at least one database, programmed with specific customer or user information to enable seamless service activation using a wireless device in communication with the at least one database.

The IoT is a rapidly growing area, with the types of devices and products having network connection capabilities ever increasing in number. Devices on an IoT capable of smart control range from locks to equipment tracking systems to home appliances to energy consumption management devices. Virtually anything that is electrically powered or is capable of sending or receiving an electrical or wireless signal can be considered within the category of things that could someday be part of the IoT.

In the past, customers have been required to request technical support by phone, fax, web form or email when devices are malfunctioning. This has led to the development of a variety of technical support software applications, which have been adapted to replace these request communications. Technical support applications offer several advantages over other forms of technical support requests, but also suffer from many drawbacks that hinder a user's ability to immediately determine the availability and expense of technical support in real time. For example, today's technical support applications require users, for example, to download a mobile application, register their names, submit information and wait for a technical support response. This is especially problematic for enterprise clients because none of these activities are transparent or trackable. Hence there is a need in the art for a system that allows for preregistration of personnel and devices and preauthotization for different user service levels within an enterprise.

Enterprise clients, in particular those with multiple sites, stand to benefit from access to a single system for the seamless maintenance and repair of all devices, appliances and the like connected on an enterprise network, wherein control over maintenance and repair activities is overseen by preauthorized personnel and these functions are provided in a way that is convenient, predictable and trackable without extensive diversion of enterprise personnel from their primary work responsibilities. According to the invention of the present disclosure, information on the enterprise network and all components connected thereto can be collected in advance and stored in at least one database, wherein technical support personnel may access IoT and user information on the at least one database in response to the pressing of a button or activation through a user interface installed on a wireless device such as a tablet or smartphone without further intervention by enterprise personnel. In one embodiment, an invention of the present disclosure incorporates a provisioned application in communication with at least one database stored locally or remotely for preauthorization and tracking of repair activities across an enterprise.

### BRIEF SUMMARY OF THE INVENTION

The invention described herein is that of a system and method for automatically activating predetermined technical support personnel in response to the pressing of a button or service activation via a provisioned application when a device connected on a network is not functioning properly. An alert device connected on an IoT such as an enterprise IoT is provided which will alert the appropriate technical support personnel when another device on the network malfunctions. The alert device may be in the form of a small electronic button that is programmed to alert appropriate technical support personnel when technical assistance is required in order to correct a malfunction on the network. In one embodiment, the network is the Internet. In another embodiment, support is provided on an emergency basis in response to an alert. In another embodiment, preauthorization of a user is achieved through programming of at least one database in communication with an alert device, along with device information associated with all devices on the IoT, for example, an enterprise IoT.

In one embodiment of the present invention, at least one database contains information on an inventory of an IoT, including, for example, a unique identifier for each thing on the network, network address, physical location, product name, make and model numbers, serial number, manufacturer, specifications, warranty information, instructions for use, repair manual and other relevant information. At least one database may also be programmed with information on an enterprise, such as enterprise name, primary location, other locations, authorized personnel names, security protocols and any other information that a customer may wish to provide. In one embodiment, at least one database of the present invention is stored tangibly on a non-transitory computer readable medium such as a local or remote server, for example and not by way of limitation.

At least one database may be stored tangibly on at least one server, for example, in communication a software application tangibly stored on a non-transitory, computer readable medium, containing instructions that when executed cause at least one processor to access the information in the database necessary to fulfill a support request and dispatch the appropriate technical support to the site of the technical support need. The invention further comprises an application program interface in communication over the Internet or another network with the user interface used to initiate the service request, as well as the technical support personnel who are as a result alerted to fulfill the request. In summary, technical support is carried out in a highly customized manner at the press of a button or interaction with a user interface of the present invention.

In one embodiment, the data stored on at least one database further includes instructions on how and when support services are to be provided, so a technician dispatched by can provide custom support services in accordance with the preferences of the enterprise. For example, the enterprise may prefer that non-emergency support services be provided only during specified hours. It may also be that certain personnel are requested to perform services on certain devices and appliances on the network. Any preference of the enterprise may be stored on the at least one database to help the technical support provider direct the provision of services in accordance with the stored preferences.

### BRIEF DESCRIPTION OF DRAWINGS

FIG. 1 illustrates a system architecture of an embodiment of the invention of the present disclosure.

FIG. 2 illustrates a simplified system process flow of a method of the present disclosure.

FIG. 3 illustrates the nexus between a system and method according to one embodiment of the invention of the present disclosure.

### DETAILED DESCRIPTION OF THE INVENTION

The invention of the present disclosure is that of a system and method of providing more efficient, customized technical support services to its users, providing users with the assurance that any number of devices, appliances and the like connected on an information or telecommunications network (referred to herein as a “network” or “IoT”) will be maintained and serviced in accordance with preset, user-defined policies tangibly stored within a programmable database accessible to users via a user interface, which may comprise a single push-button that activates a service request process or a provisioned application that allows for additional control over service activation.

In one embodiment, at least one database is populated with extensive information in advance of system activation for a given individual user or enterprise customer related to its IoT and the devices connected thereon. The at least one database may include preauthorization information enabling only authorized individual users to initiate a process of the present invention upon service activation. The at least one database contains information regarding the IoT, the devices on the network, the services desired, the specific manner in which the services are to be provided and network credentials necessary to access the IoT to locate and identify devices on the network to be serviced, such as by a unique Internet protocol (IP) address.

In one embodiment, information about a network and the devices connected thereon may be provided by a user during an intake process to a system manager for entry into at least one database. The information may be provided in physical form, or more preferably in the form of electronic data stored on a non-transitory, computer readable medium, either located within the network or accessed through the devices connected on the IoT. Once the system manager is equipped with a means for collecting all the data available on the network or the devices connected thereon, the system manager can populate and organize the at least one database for tangible storage on a non-transitory computer readable medium. In a one embodiment, the at least one database is stored on at least one server, which may be local to the network or remote, and preferably on a plurality of servers for redundancy. The accompanying drawings provide illustrations of certain system components, architectures and process flows.

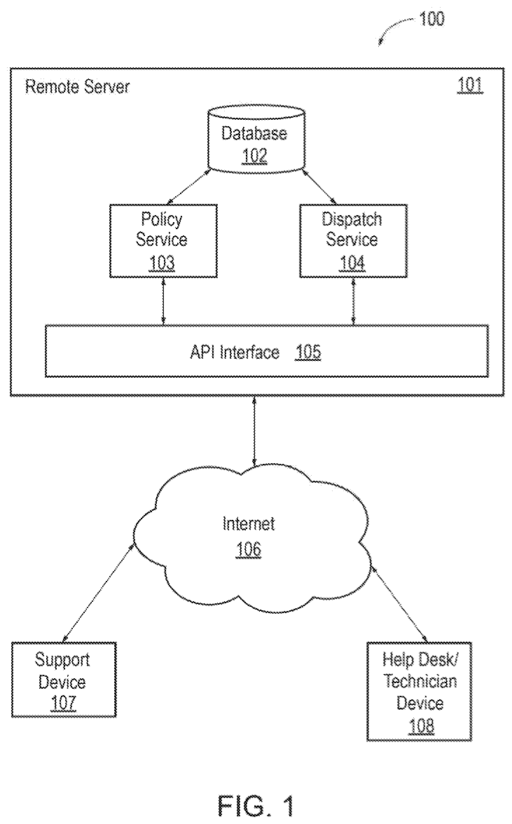

Referring to FIG. 1, a representative system architecture 100 according to one embodiment is shown. In this embodiment, a database 102 or equivalent data repository residing on at least one server 101 or equivalent storage medium is in communication with at least one software module, also tangibly stored on the at least one server 101 or equivalent. In this embodiment, the at least one software module comprises a policy service module 103 and dispatch service module 104, each being in communication with a network such as the Internet 106 through an application program interface 105. A connected support device 107 may initiate a service request over the Internet 106 or like network and application program interface 105, triggering the policy service module 103 to cause a processor (not shown) to access the database 102 to determine the device to be repaired and any rules associated with servicing the device. Similarly, the dispatch service module 104 causes the processor to access the database 102 to determine the identity, location, type of device and repair needed, for example.

Collectively, the software modules residing on the at least one server 101 or equivalent contain instructions which when executed by a processor cause the processor to determine the particulars of the repair need and any predefined policies contained in the database 102 that govern how service is to be carried out. Overall, the system enables its authorized users to initiate service requests for device on the IoT with the push of a button, or by providing additional details as discussed below.

Continuing with the embodiment of FIG. 1, the policy service module 103 comprises a software application residing on a non-transitory computer-readable medium, tangibly storing computer program instructions, which when executed by a processor cause the processor to receive “event information” from a support device 107 in response to user activation of the support device 107, e.g., by pressing a button. In one embodiment, the event information comprises the location of at least one device on the IoT to be repaired, updated or serviced, including its identity, location and the nature of the service needed. The policy service module 103 may then, based on the incoming event information, query the database 102 for information on the manner in which service is to be conducted based on the event information so the appropriate dispatch may be queued by the dispatch service module 104.

The dispatch service module 104 comprises a software application residing on a non-transitory computer-readable medium, tangibly storing computer program instructions, which when executed by a processor cause the processor to initiate an alert that is transmitted through the application program interface 105 over the Internet 106 such that the alert reaches the appropriate support provider, such as a help desk technician capable of servicing one or more devices on the IoT remotely, a field service provider as may be required to visit the site of the affected device and perform service on the physical device, or the device itself in cases, for example, where the device is a computer in need of application patching and the necessary testing is provisioned on a network environment in communication with the device.

In certain embodiments, the network over which an alert is transmitted comprises the Internet. An alert may consist of any means capable of alerting a person, or where remote service may be provided by a physical or virtual machine such as a computer in connection with the device to be serviced over the network, a signal that when received by the physical or virtual machine causes the machine to execute instructions for remote repair or service of the device in need.

In one embodiment, an application program interface 105 is used to send and receive information over the Internet and is configured to communicate policy service instructions received by one or more processors from the policy service module 103 to the appropriate help desk technician or device 108 in response to execution of dispatch service instructions. In one embodiment, the support device 107 may be serviced remotely with or without human intervention, such as when service updates are made available by the manufacturer of the support device for download. In other embodiments, a service call from an equipment manufacturer may be required, and the policy instructions associated with the support device and stored on the database cause specific personnel to be dispatched at predetermined times to carry out the necessary service such that an accounting for the service can take place seamlessly between the user or enterprise utilizing the system and the support provider based on specific instructions provided by the user to the system manager.

In one embodiment, the support device comprises a button that is pressed by the user to initiate an event, with no additional steps required by the user to have a device on the IoT serviced in accordance with its then current needs. The support device is in communication, preferably via the Internet but alternatively between private networks, enabling transmission of event information to at least one server, preferably a remote server, whereon are stored at least one database containing a complete repository of data on the user's IoT necessary to service any device connected thereon, one or more of a policy service module and a dispatch service module with instructions stored thereon as provided herein for sending and receiving information through the application program interface, thereby executing the sequence of events necessary to cause all necessary services to devices on the IoT to be provided at the press of the button. The invention described herein eliminates the need for users and enterprises to spend time seeing that the service needs are met beyond the press of a button.

Once a user activates a support device 107 thereby initiating a process of the present invention, an “event” is transmitted over the Internet to a remote server through the application program interface 105, which causes the execution of instructions stored tangibly on service modules, which when executed by a processor cause the processor to access at least one database to determine which device on the IoT is in need of service and dispatch the appropriate instructions so the appropriate enterprise personnel can be notified via mobile application and the appropriate service order filled by the appropriate support technician, or remote service can be activated automatically.

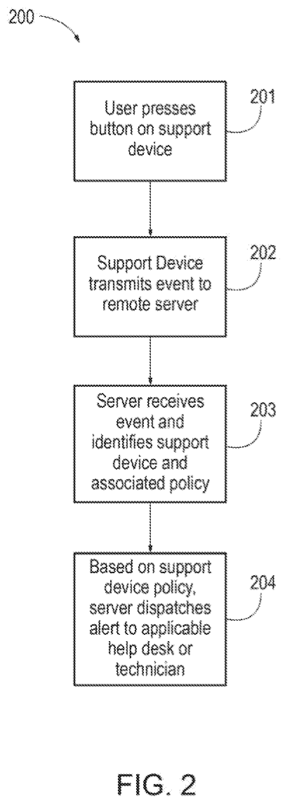

Turning to FIG. 2, a typical process flow 200 of the present disclosure comprises at least the steps of activation 201, event transmission 202, policy verification 203 and dispatch 204. Activation 201 may be by the press of a button or equivalent, or more secure event initiation through a more sophisticated user interface. Regardless of the activation means, event transmission 202 is required to trigger the process of executing a service request. Similarly, receipt on at least one server or equivalent where service modules are stored is required for policy verification 203 so that the correct instructions can be carried out in providing service. Policy verification 203 must occur before dispatch 204 of support.

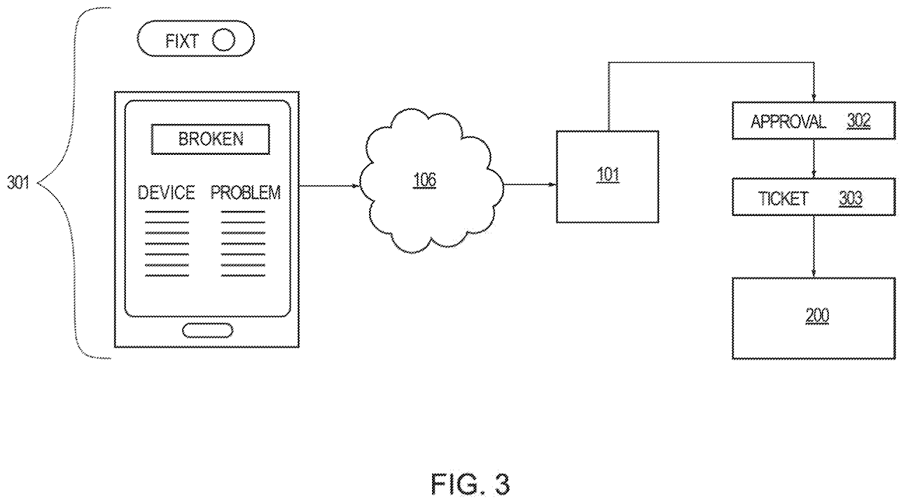

To enable system activation from extremely remote locations, for example, a provisioned system as shown in FIG. 3 may be developed such that a provisioned application may reside on a server or the like 101 and be accessed remotely via the Internet 106 with enabled security options for accessing a system via virtual private network or the like. A provisioned system as in FIG. 3 may include components that enable email confirmation or local approval for remote service requests. Such a framework may be set up so that additional confirmations are required before dispatch can occur. A user interface 301 may be a simple push-button or an application installed on a laptop computer, smartphone or the like, enabling additional control over the service request, such as but allowing the user to identify the device in need of repair and the nature of the repair to be executed. Once a request is initiated and transmitted to a system of the present invention, an optional approval 302 may be authorized and a ticket 303 generated so the service can be dispatched and a process flow 200 executed.

It is an object of the invention of the present disclosure to enable a large business enterprise with hundreds if not thousands of connected devices on a private or public IoT to register for service of the type enabled by the present invention and populate a database of the present invention with unique device identifiers for every connected device on the IoT and associate each identifier with information about the corresponding device, such as but not limited to the type of device, physical location, and repair instructions such as preferred hours during which service should be conducted, security measures and so on. When service is dispatched according to the present method, it is then conducted according to the stated preferences of the enterprise and without the need for multiple tracking and logging steps as is common in the state of the art. It is thus an outcome provided by the invention that enterprise assets are maintained with far greater efficiency than is currently possible.

What is claimed is:

1. A system for executing a service request for a network device in need of service, the system comprising:
at least one support device and at least one dispatch device, each being in network communication with at least one server, the at least one server comprising a non-transitory computer readable medium tangibly storing;
at least one database;
at least one application program interface;
at least one policy service module tangibly storing instructions which when executed by a processor cause the processor to verify a policy associated with the service request by accessing policy information within the database; and
at least one dispatch service module tangibly storing instructions which when executed by a processor cause the processor to transmit the service request to a dispatch device, the service request containing all the necessary instructions to service the network device in accordance with user preferences;
wherein upon receipt of the service request by the dispatch device, the service request is executed.

2. The system of claim 1, wherein the at least one support device comprises a single push button that enables the service request to be executed according to the user preferences.

3. The system of claim 1, wherein the at least one support device comprises a user interface that allows a user to select a device on an Internet of things to receive service.

4. The system of claim 3, wherein the user interface further allows the user to select the type of service the device is to receive.

5. The system of claim 1, wherein the user preferences are stored within the database.

6. A method of servicing at least one network device, the method comprising:
providing a system according to claim 1;
populating the database with information associated with the at least one device, the information comprising a unique identifier, an Internet protocol address, a physical description of the device, a physical location of the device and user preferences for servicing the device;
requesting service to the at least one network device via the support device, wherein upon request the support device communicates with the application program interface and causes the policy service module to access the database and obtain instructions for servicing the at least one network device;
wherein once obtained, the instructions are executed by a processor and cause the processor to create a service ticket and transmit the ticket to a technician device;
wherein once received, the instructions are executed, causing the service method to be completed.

7. The method of claim 6, further comprising the step of obtaining at least one approval for the service method to be completed.

8. The method of claim 6, wherein the service ticket contains instructions for completing the service request.
